(19) United States
(12) Patent Application Publication
(10) Pub. No.: US 2024/0426792 A1
(43) Pub. Date: Dec. 26, 2024

(54) PROCESSING SYSTEM, PROCESSING DEVICE, PROCESSING METHOD, AND STORAGE MEDIUM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Masahiro SAITO, Yokohama (JP); Hiromasa TAKAHASHI, Minato (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/825,430

(22) Filed: Sep. 5, 2024

Related U.S. Application Data
(63) Continuation of application No. PCT/JP2023/011865, filed on Mar. 24, 2023.

(30) Foreign Application Priority Data
Mar. 24, 2022 (JP) 2022-047962

(51) Int. Cl. G01N 29/265; G01N 29/06; G01N 29/11

(52) U.S. Cl. CPC G01N 29/265; G01N 29/06; G01N 29/11; G01N 2291/267

(57) ABSTRACT

According to one embodiment, a processing system includes a manipulator, a detection device, and a processing device. The detection device is mounted to the manipulator. The detection device includes a detector, a first propagating member, and a second propagating member. The detector is configured to transmit an ultrasonic wave toward an object and detect a reflected wave. The first propagating member is mounted to the detector, the ultrasonic wave propagating through the first propagating member. The second propagating member is mounted to the first propagating member, the ultrasonic wave propagating through the second propagating member, the second propagating member being softer than the first propagating member. The processing device is configured to receive intensity data from the detector and detect a surface position of the object in the intensity data, the intensity data being of an intensity of the reflected wave.

### CROSS-REFERENCE TO RELATED APPLICATIONS

This is a continuation application of International Patent Application PCT/JP2023/011865, filed on Mar. 24, 2023. This application also claims priority to Japanese Patent Application No. 2022-047962, filed on Mar. 24, 2022. The entire contents of which are incorporated herein by reference.

### FIELD

Embodiments of the invention generally relate to a processing system, a processing device, a processing method, and a storage medium.

### BACKGROUND

There is a system that includes a manipulator and a detection device configured to transmit and receive an ultrasonic wave. It is desirable to improve the convenience of such a system.

### BRIEF DESCRIPTION OF THE DRAWINGS

FIG. 1 is a schematic view showing a processing system according to an embodiment;

FIG. 2 is a perspective view showing a detection device according to the embodiment;

FIG. 3 is a perspective view showing the distal end of the detection device according to the embodiment;

FIGS. 4A to 4C are schematic views for describing the detection result of the detection device according to the embodiment;

FIG. 5 is a schematic view illustrating a three-dimensional detection result obtained by probing;

FIG. 6 is a flowchart showing a processing method according to the embodiment;

FIG. 7 is a schematic view for describing an angle adjustment of the detection device;

FIGS. 8A to 8C are examples of images of extracted data;

FIG. 9 is a schematic view showing a detection device according to a reference example;

FIGS. 10A and 10B are a perspective view and a bottom view showing a second propagating member;

FIGS. 11A and 11B are side views showing the second propagating member;

FIGS. 12A and 12B are a bottom view and a side view showing a portion of the detection device according to the embodiment;

FIGS. 13A and 13B are side views showing the detection device according to the embodiment;

FIGS. 14A and 14B are bottom views showing portions of the detection device according to the embodiment;

FIGS. 15A and 15B are a side view and a perspective view illustrating the detection device according to the embodiment;

FIGS. 16A and 16B are side views illustrating the distal end of the detection device according to the embodiment;

FIG. 17 is a flowchart showing a processing method according to a first modification of the embodiment;

FIG. 18 is a flowchart showing a processing method according to a second modification of the embodiment;

FIG. 19 is a schematic view showing an example using the processing system according to the embodiment; and

FIG. 20 is a schematic view illustrating a hardware configuration.

### DETAILED DESCRIPTION

According to one embodiment, a processing system includes a manipulator, a detection device, and a processing device. The detection device is mounted to the manipulator. The detection device includes a detector, a first propagating member, and a second propagating member. The detector is configured to transmit an ultrasonic wave toward an object and detect a reflected wave. The first propagating member is mounted to the detector, the ultrasonic wave propagating through the first propagating member. The second propagating member is mounted to the first propagating member, the ultrasonic wave propagating through the second propagating member, the second propagating member being softer than the first propagating member. The processing device is configured to receive intensity data from the detector and detect a surface position of the object in the intensity data, the intensity data being of an intensity of the reflected wave.

Hereinafter, embodiments of the invention will be described with reference to the drawings.

The drawings are schematic or conceptual, and the relationship between the thickness and width of each portion, the proportions of sizes among portions, and the like are not necessarily the same as the actual values. Even the dimensions and proportion of the same portion may be illustrated differently depending on the drawing.

In the specification and drawings, components similar to those already described are marked with like reference numerals, and a detailed description is omitted as appropriate.

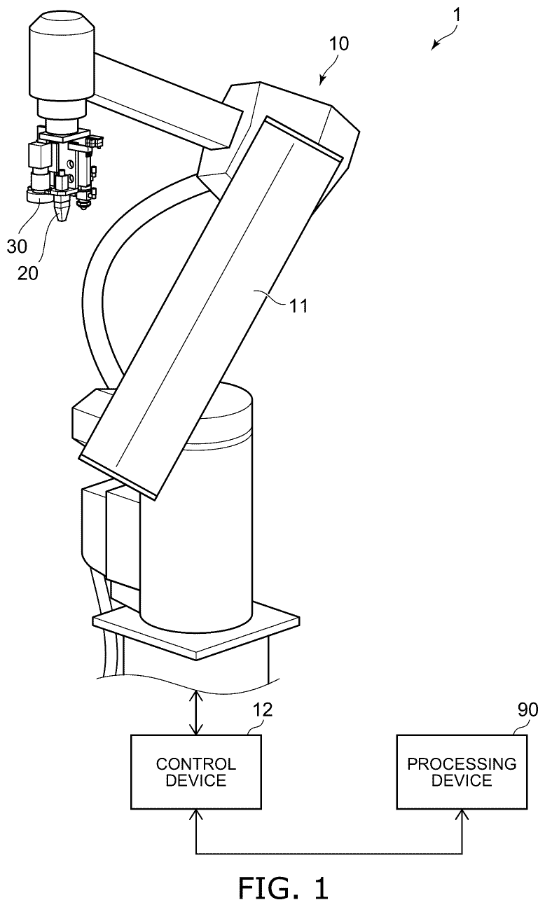

FIG. 1 is a schematic view showing a processing system according to an embodiment.

As shown in FIG. 1, the processing system 1 according to the embodiment includes a robot 10, a detection device 20, and a processing device 90. The robot 10 includes a manipulator 11 and a control device 12.

The manipulator 11 is, for example, vertical articulated. The manipulator 11 may be horizontal articulated or parallel link. The manipulator 11 may be a combination of at least two manipulators selected from vertical articulated, horizontal articulated, and parallel link. The control device 12 controls operations of the manipulator 11. The control device 12 is a so-called robot controller.

The detection device 20 is mounted to the distal end of the manipulator 11. The control device 12 moves the detection device 20 by operating the manipulator 11. The manipulator 11 operates so that the distal end of the detection device 20 contacts an object. For example, the position at which the distal end of the detection device 20 contacts the object is pre-taught. The control device 12 operates the manipulator 11 so that the distal end of the detection device 20 is positioned at the teaching point. The detection device 20 transmits an ultrasonic wave toward the object and detects a reflected wave of the ultrasonic wave. The object is, for example, a joined body joined by welding. The welding is laser welding, arc welding, resistance spot welding, etc. The invention according to the embodiment is especially favorable for a joined body on which resistance spot welding is performed.

As shown in FIG. 1, an imaging device 30 may be further included at the distal end of the manipulator 11. The imaging device 30 acquires an image by imaging the object. The processing device 90 detects the weld portion of the joined body from the obtained image. The control device 12 may operate the manipulator 11 so that the distal end of the detection device 20 contacts the detected weld portion.

### Detection Device

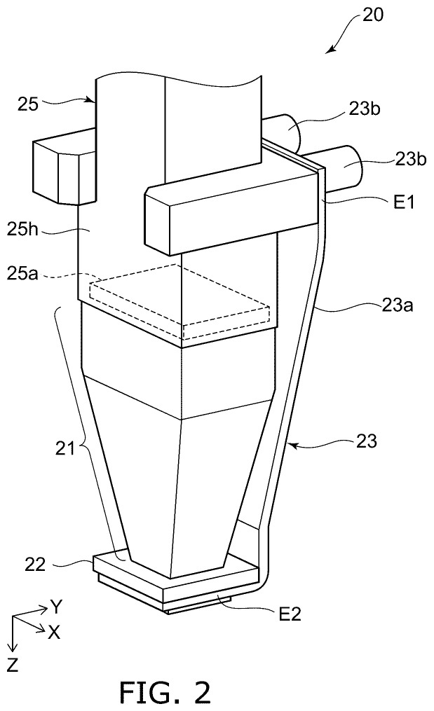

FIG. 2 is a perspective view showing the detection device according to the embodiment.

As shown in FIG. 2, the detection device 20 according to the embodiment includes a first propagating member 21, a second propagating member 22, a fixture 23, and a detector 25.

The detector 25 includes an element array 25a. The element array 25a includes multiple detection elements. The detection elements each transmit an ultrasonic wave. Also, detection elements each detect a reflected wave of the ultrasonic wave. Herein, the transmission of the ultrasonic wave and the detection of the reflected wave by the detector 25 is called probing. The side of the element array 25a is surrounded with a housing 25h of the detector 25. The side refers to directions crossing the transmitting direction of the ultrasonic wave.

The first propagating member 21 is mounted to the detector 25 (the housing 25h). The first propagating member 21 can transmit the ultrasonic wave. For example, the first propagating member 21 contacts the detector 25. Or, another member that can transmit the ultrasonic wave may be located between the first propagating member 21 and the detector 25.

The second propagating member 22 is mounted to the first propagating member 21 by the fixture 23. The first propagating member 21 is positioned between the detector 25 and the second propagating member 22. The second propagating member 22 can transmit the ultrasonic wave. The ultrasonic wave that propagates through the first propagating member 21 propagates through the second propagating member 22 and is emitted outside the detection device 20.

The fixture 23 is omissible when the second propagating member 22 can be mounted to the first propagating member 21 without the fixture 23. For example, the second propagating member 22 may be mounted to the first propagating member 21 with an adhesive medium.

The first propagating member 21 is a solid. The first propagating member 21 is hard enough that the first propagating member 21 substantially does not deform when operating the detection device 20. As a result, damage of the element array 25a can be suppressed. The second propagating member 22 is a gel and is not a liquid. The second propagating member 22 is softer than the first propagating member 21. In other words, the hardness of the second propagating member 22 is less than the hardness of the first propagating member 21. Therefore, the second propagating member 22 deforms more easily than the first propagating member 21. The first propagating member 21 is soft enough that the first propagating member 21 can deform according to the surface shape of the object of the inspection when operating the detection device 20.

The fixture 23 fixes the second propagating member 22 in a state in which the second propagating member 22 contacts the first propagating member 21. The fixture 23 detachably fixes the second propagating member 22 with respect to the first propagating member 21.

Herein, the direction from the first propagating member 21 toward the second propagating member 22 is taken as a Z-direction. One direction crossing the Z-direction is taken as an X-direction. One direction crossing the Z-X plane is taken as a Y-direction. For example, the X-direction, the Y-direction, and the Z-direction are mutually-orthogonal.

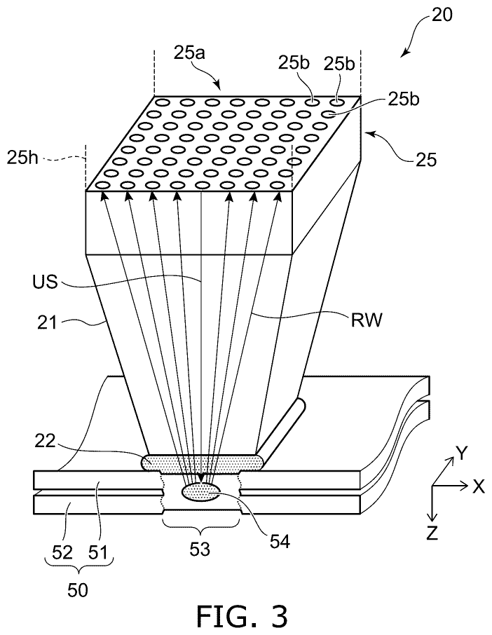

FIG. 3 is a perspective view showing the distal end of the detection device according to the embodiment.

As shown in FIG. 3, the element array 25a is located inside the detector 25. The element array 25a includes multiple detection elements 25b. For example, the detection element 25b is a transducer and emits an ultrasonic wave of a frequency of not less than 1 MHz and not more than 100 MHZ. The multiple detection elements 25b are arranged along the X-direction and the Y-direction.

FIG. 3 shows the state when a joined body 50 is being probed. In the joined body 50, a metal member 51 (a first member) and a metal member 52 (a second member) are joined by resistance spot welding at a weld portion 53. In the weld portion 53, a portion of the metal member 51 and a portion of the metal member 52 melt and mix to form a solidified portion 54 (a nugget). The second propagating member 22 that contacts the joined body 50 deforms along the shape of the surface of the joined body 50. As a result, for example, the second propagating member 22 fills between the joined body 50 and the first propagating member 21. The detection elements 25b each transmit an ultrasonic wave US toward the joined body 50. The transmitted ultrasonic wave US passes through the first and second propagating members 21 and 22 and propagates toward the joined body 50. At least a portion of the ultrasonic wave US is reflected by the joined body 50. The detection elements 25b each receive a reflected wave RW from the joined body 50.

As a more specific example as shown in FIG. 3, one detection element 25b transmits the ultrasonic wave US toward the weld portion 53. A portion of the ultrasonic wave US is reflected by the upper surface or the lower surface of the joined body 50, etc. The multiple detection elements 25b each receive (detect) the reflected wave RW. The detection elements 25b sequentially transmit the ultrasonic waves US; and the reflected waves RW of the ultrasonic waves US are detected by the multiple detection elements 25b. As a result, a detection result of the reflected wave indicating the state of the weld portion 53 vicinity is obtained.

The processing device 90 controls the element array 25a of the detection device 20. In the probing, an electrical signal is transmitted from the processing device 90 to each detection element 25b; and an ultrasonic wave is transmitted from each detection element 25b. Also, the detection elements 25b each output an electrical signal according to the detection of the reflected wave. The magnitude of the electrical signal corresponds to the intensity of the reflected wave. The detection elements 25b each transmit intensity data of the detected intensity of the reflected wave to the processing device 90. The processing device 90 performs various processing based on the intensity data.

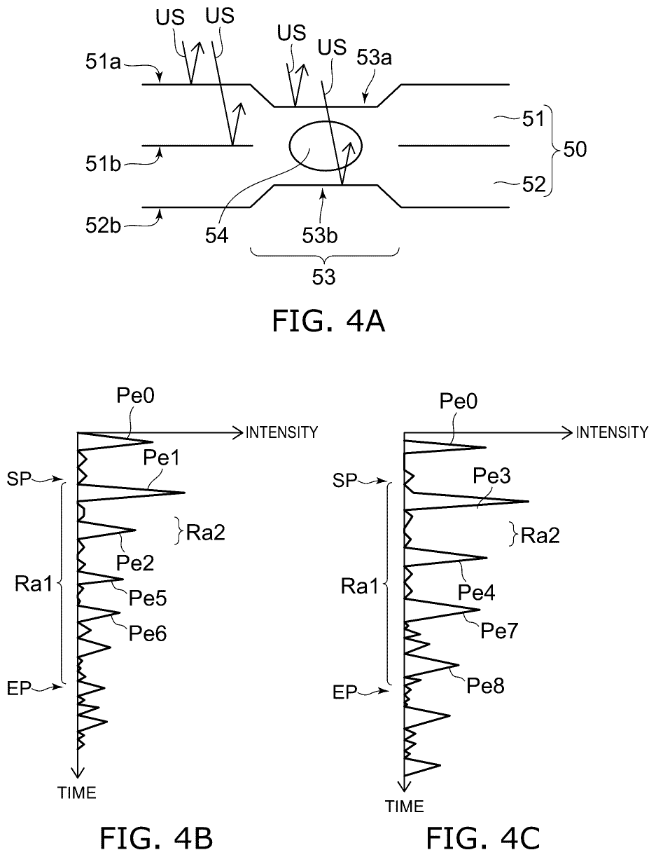

FIGS. 4A to 4C are schematic views for describing the detection result of the detection device according to the embodiment.

When the ultrasonic wave is transmitted from the detection device 20 as shown in FIG. 4A, a portion of the ultrasonic wave US is reflected by an upper surface 51a of the metal member 51 or an upper surface 53a of the weld portion 53. Another portion of the ultrasonic wave US is incident on the joined body 50 and is reflected by a lower surface 51b of the metal member 51 or a lower surface 53b of the weld portion 53.

The Z-direction positions of the upper surface 51a, the lower surface 51b, the upper surface 53a, and the lower surface 53b are different from each other. In other words, the Z-direction distances between the detection element 25b and these surfaces are different from each other. The detection element 25b detects peaks of the reflected wave intensities when detecting the reflected waves from these surfaces. Which surface reflected the ultrasonic wave US can be determined by calculating the time until each peak is detected after transmitting the ultrasonic wave US.

FIGS. 4B and 4C are graphs illustrating the relationship between the time after transmitting the ultrasonic wave US and the intensity of the reflected wave RW. Here, the intensity of the reflected wave RW is expressed as an absolute value. The graph of FIG. 4B illustrates the detection result of the reflected wave RW from the upper surface 51a and the lower surface 51b of the metal member 51 and a lower surface 52b of the metal member 52. The graph of FIG. 4C illustrates the detection result of the reflected wave RW from the upper surface 53a and the lower surface 53b of the weld portion 53.

In the graphs of FIGS. 4B and 4C, a peak Pe0 is based on the reflected wave RW from the interface between the first propagating member 21 and the second propagating member 22. A peak Pe1 is based on the reflected wave RW from the upper surface 51a. A peak Pe2 is based on the reflected wave RW from the lower surface 51b. Times from the transmission of the ultrasonic wave US until the peak Pe1 and the peak Pe2 are detected correspond respectively to the Z-direction positions of the upper surface 51a and the lower surface 51b of the metal member 51.

Similarly, a peak Pe3 is based on the reflected wave RW from the upper surface 53a. A peak Pe4 is based on the reflected wave RW from the lower surface 53b. The times from the transmission of the ultrasonic wave US until the peak Pe3 and the peak Pe4 are detected correspond respectively to the Z-direction positions of the upper surface 53a and the lower surface 53b of the weld portion 53.

The intensity data also includes multiple peaks (e.g., peaks Pe5 to Pe8) after the peaks Pe2 and Pe4. These peaks are based on the reflected wave from the lower surface 52b, multiple-reflection waves of the ultrasonic wave multiply reflected between the surfaces of the joined body 50, etc.

The intensity of the reflected wave may be expressed in any form. For example, the reflected wave intensity that is output from the detection element 25b includes positive values and negative values according to the phase. Various processing may be performed based on the reflected wave intensity including positive values and negative values. The reflected wave intensity that includes positive values and negative values may be converted into absolute values. The average value of the reflected wave intensities may be subtracted from the reflected wave intensity at each time. Or, the weighted average value, the weighted moving average value, etc., of the reflected wave intensities may be subtracted from the reflected wave intensity at each time. The various processing described in the application can be performed even when the results of such processing applied to the reflected wave intensity are used.

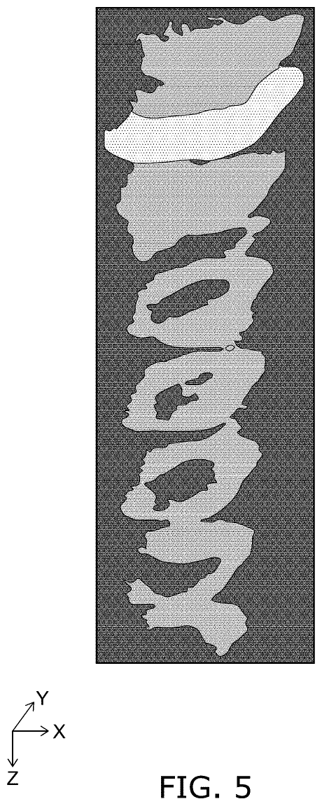

FIG. 5 is a schematic view illustrating a three-dimensional detection result obtained by the probing.

In the probing as described above, the detection elements 25b sequentially transmit ultrasonic waves; and the multiple detection elements 25b detect the reflected waves. In the specific example shown in FIG. 3, sixty-four, i.e., 8×8, detection elements 25b are included. In such a case, the sixty-four detection elements 25b sequentially transmit ultrasonic waves. One detection element 25b repeatedly detects the reflected wave sixty-four times. The detection result of the Z-direction reflected wave intensity distribution is output sixty-four times from one detection element 25b. The sixty-four reflected wave intensity distributions output from the one detection element 25b are summed. The summed intensity distribution is the intensity distribution for one probing at the coordinate at which the one detection element 25b is located. Similar processing is performed for the detection results of the sixty-four detection elements 25b. As a result, the Z-direction reflected wave intensity distribution is generated at each point in the X-Y plane. FIG. 5 shows an image of the three-dimensional intensity distribution. The portions of FIG. 5 at which the luminance is high are portions at which the reflected wave intensity of the ultrasonic wave is relatively large.

The intensities of the peaks included in the reflected waves, the Z-direction positions of the peaks, etc., change according to the state of the object. Therefore, information of the object can be obtained from the intensity data. For example, the intensity data can be utilized to inspect the internal structure of the object.

### Processing Method

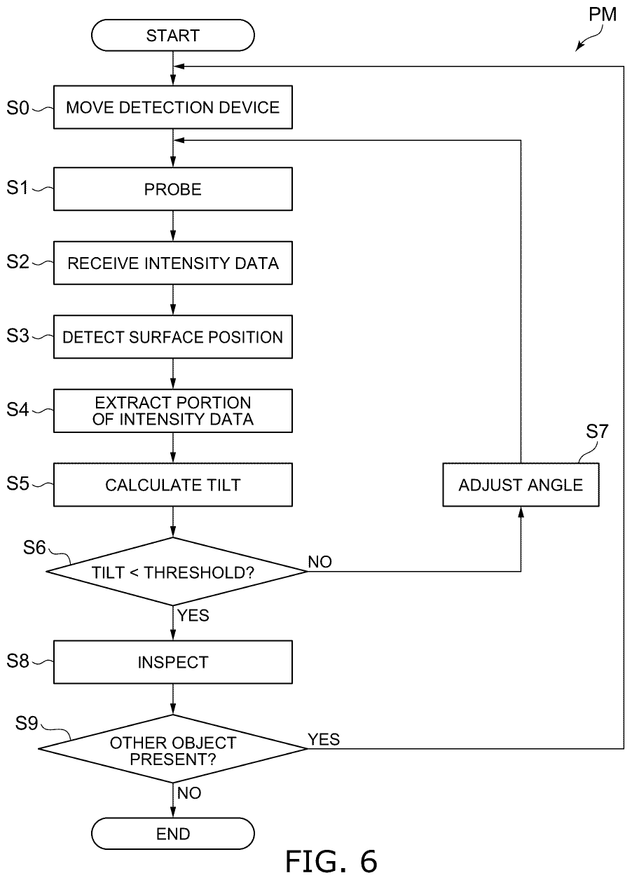

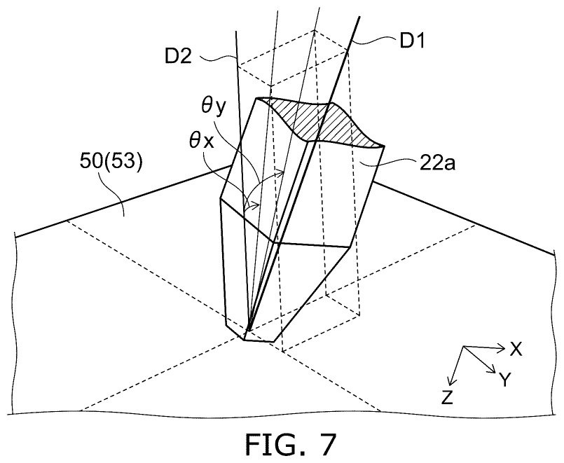

FIG. 6 is a flowchart showing a processing method according to the embodiment. FIG. 7 is a schematic view for describing an angle adjustment of the detection device.

In the processing method PM shown in FIG. 6, the control device 12 moves the detection device 20 by operating the manipulator 11 (step S0). As a result, the distal end of the detection device 20 contacts the object (the weld portion 53). The processing device 90 causes the detection device 20 to probe (step S1). The processing device 90 receives the intensity data obtained by the probing from the detection device 20 (step S2). The processing device 90 detects the surface position of the object in the intensity data (step S3).

For example, as shown in FIGS. 4A to 4C, the intensity data includes peaks based on the reflected waves from the surfaces. The thickness of the first propagating member 21 does not change due to contact of the detection device 20 with the object, etc. Therefore, the position of the interface between the first propagating member 21 and the second propagating member 22 is substantially constant in the intensity data. On the other hand, the positions of the peaks after the peak Pe0 change according to the thickness when the second propagating member 22 deforms, the state of the second propagating member 22, etc. Therefore, the positions of the peaks may change in the intensity data. The processing device 90 detects the position of the surface (the upper surface 51a or 53a) of the object in the intensity data. For example, the processing device 90 detects one or more peaks by comparing the peaks included in the intensity data and a preset first threshold. The processing device 90 detects the peak (a first peak) appearing first (at the shallowest position) in the intensity data as the peak Pe0. After detecting the peak Pe0, the processing device 90 detects the peak (a second peak) that is the peak first having an intensity greater than a preset second threshold as a reflected wave from the surface of the object. The processing device 90 detects the position (the time) at which the first peak detected after the peak Pe0 occurred as the “surface position” in the Z-direction of the object. The first threshold for detecting the peak Pe0 and the second threshold for detecting the surface position may be the same or different from each other.

The processing device 90 extracts a portion of the intensity data based on the detected surface position (step S4). For example, a Z-direction length of the range to be extracted is preset. The processing device 90 sets the detected surface position as the starting point in the Z-direction, and sets the end point of the range based on the starting point. The processing device 90 extracts the range from the starting point to the end point from the intensity data. Or, the range to be extracted may be set according to the peaks included in the intensity data. For example, the range from where the peak corresponding to the surface position is detected until a preset number of peaks is detected may be extracted from the intensity data. A portion of the intensity data may or may not be extracted in the X-direction and Y-direction.

As an example, intensity data included in a range Ra1 from a starting point SP to an end point EP among the intensity data shown in FIGS. 4B and 4C is extracted in step S4. Hereinafter, a portion of the entire intensity data extracted by the processing device 90 is called the “extracted data”. The processing device 90 can perform various processing by using the extracted data. For example, the processing device 90 uses the extracted data to calculate the tilt of the detection device 20 (step S5) and inspect the object (step S8). By extracting a portion of the intensity data, the calculation amount necessary for the subsequent processing can be reduced, and the processing can be performed more quickly.

In step S5, the processing device 90 calculates the tilt of the detection device 20 with respect to the object. As shown in FIG. 7, the tilt is represented by an angle ox around the X-direction and an angle θy around the Y-direction between a direction D1 of the detection device 20 and a normal direction D2 of the weld portion 53 surface. The direction D1 is perpendicular to the arrangement directions of the multiple detection elements 25b.

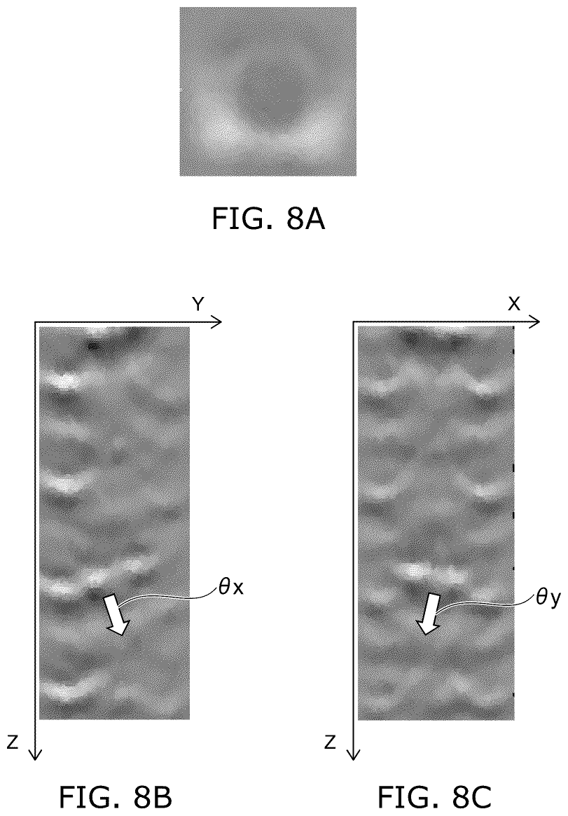

FIGS. 8A to 8C are examples of images of the extracted data.

The method for calculating the tilt will now be described. FIG. 8A is an image of the reflected wave intensity distribution in the X-Y plane of the extracted data. FIG. 8B is an image of the reflected wave intensity distribution in the Y-Z plane of the extracted data. FIG. 8C is an image of the reflected wave intensity distribution in the X-Z plane of the extracted data. In the images of FIGS. 8A to 8C, the luminance corresponds to the reflected wave intensity. In other words, a brighter pixel color indicates that the reflected wave intensity is high at that point.

As shown in FIG. 8B, the angle θx is calculated based on the detection result in the Y-Z plane. As shown in FIG. 8C, the angle θy is calculated based on the detection result in the X-Z plane. Specifically, the processing device 90 calculates the average of the three-dimensional luminance gradients. The processing device 90 uses the average of the gradients around the X-direction as the angle θx. The processing device 90 uses the average of the gradients around the Y-direction as the angle θy.

There are cases where the upper surface 53a and the lower surface 53b of the weld portion 53 are tilted with respect to the upper surface 51a of the metal member 51. The tilt is due to the weld portion 53 including the solidified portion 54, shape deformation in the welding process, etc. In such a case, it is desirable for the ultrasonic wave US to be transmitted, on average, along a direction perpendicular to the upper surface 53a and the lower surface 53b. As a result, the ultrasonic wave is reflected more intensely by the upper surface 53a and the lower surface 53b. The components of the reflected waves at the upper surface 53a and the lower surface 53b in the intensity data can be increased. As a result, for example, the accuracy of the inspection can be increased.

The processing device 90 determines whether or not the calculated tilt is less than a preset threshold (step S6). When the tilt is not less than the threshold, the processing device 90 transmits the tilt to the control device 12. The control device 12 operates the manipulator 11 according to the received tilt and adjusts the angle between the object and the detection device 20 (step S7). As a result, the tilt of the detection device 20 with respect to the object is reduced. After adjusting the angle, step S0 is re-performed. The surface position that is detected in the first step S3 can be utilized in step S3 which is performed subsequently. Therefore, the detection of the surface position is omissible.

When the tilt is less than the threshold, the processing device 90 inspects the object (step S8). Specifically, the processing device 90 determines whether or not the peak Pe2 is present in the Z-direction reflected wave intensity distribution at multiple points in the X-Y plane. As an example, the processing device 90 detects a peak in a prescribed range in the Z-direction in which the peak Pe2 may be detected. The prescribed range is preset according to the detected surface position, the thickness of the metal member 51, etc., as referenced to the timing at which the ultrasonic wave was transmitted. The prescribed range may be set using the starting point of the extracted data as a reference. In such a case, the prescribed range can be set without considering the surface position.

For example, a range Ra2 is set as a prescribed range in the intensity data shown in FIGS. 4B and 4C. The range Ra2 includes the peak Pe2. The range Ra2 is set using the starting point SP of the range Ra1 as a reference. The processing device 90 compares the intensity of the peak within the range Ra2 with a prescribed threshold. When the peak is greater than the threshold, the processing device 90 determines that the peak is the peak Pe2. The point at which the peak Pe2 is present in the X-Y plane corresponds to the point at which the lower surface 51b is present. In other words, the presence of the peak Pe2 indicates that the metal members 51 and 52 are not joined at that point. The processing device 90 determines that the point at which the peak Pe2 is detected is not joined.

The processing device 90 sequentially determines whether or not multiple points in the X-Y plane are joined. The set of points determined to be joined corresponds to the weld portion 53. For example, the inspection determines whether or not the weld portion 53 is formed. Also, the diameter (the major diameter or the minor diameter) of the weld portion 53 in the X-Y plane is calculated in the inspection. The goodness of the weld portion 53 may be inspected by comparing the calculated diameter with a threshold.

The control device 12 determines whether or not other objects of detection are present (step S9). In other words, the control device 12 determines whether or not there are weld portions 53 that still are not inspected. When another object is present, step S0 is re-performed for the object.

Advantages of the embodiment will now be described.

### First Advantage

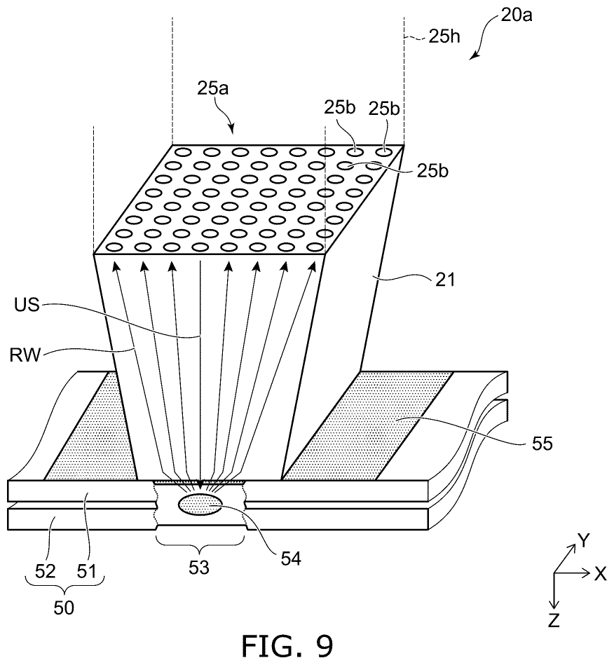

FIG. 9 is a schematic view showing a detection device according to a reference example.

The detection device 20a according to the reference example does not include the second propagating member 22. Instead of the second propagating member 22, a liquid couplant 55 is coated onto the surface of the object. The couplant 55 makes it easier for the ultrasonic wave to propagate between the detection device 20 and the object.

When the couplant is used, it is necessary to wipe the couplant 55 after probing. If the couplant 55 remains adhered to the object, alteration (e.g., rust), degradation, etc., of the surface of the object may occur. However, it takes time to wipe the couplant 55. To reduce the time necessary for the probing, there is a need for technology that can omit coating and wiping of the couplant 55.

For this problem, the detection device 20 according to the embodiment can utilize the second propagating member 22 instead of a couplant liquid. The second propagating member 22 is softer than the first propagating member 21 and is deformable according to the surface shape of the object when operating the detection device 20. By the deformation of the second propagating member 22 and by the second propagating member 22 filling between the first propagating member 21 and the object, air between the first propagating member 21 and the object can be reduced. By using the second propagating member 22, a couplant is unnecessary when probing. The time necessary for the probing can be reduced, and the convenience of the processing system 1 can be improved.

### Second Advantage

The processing of detecting the surface position of the object is performed as described above for the intensity data obtained by the detection device 20. The surface position is used to extract a portion of the intensity data. Or, the surface position also may be utilized when determining joint or non-joint of the joined body 50 at multiple points in the X-Y plane.

When the robot 10 is used to probe, the detection of the surface position of the intensity data can be omitted. For example, the point of the object to be probed is pre-taught to the robot 10. Compared to manual work, the robot 10 can set the position and the angle of the detection device 20 more accurately. The relationship between the detection device 20 and the surface position of the object is substantially fixed, and the surface position in the intensity data also is set. By presetting the surface position, the detection of the surface position can be omitted. In particular, when the first propagating member 21 shown in FIG. 9 is caused to contact the object via the couplant 55, the first propagating member 21 substantially does not deform, and so the positional relationship between the detection device 20 and the surface position of the object is set with higher accuracy.

On the other hand, when the second propagating member 22 is used, the second propagating member 22 deforms along the shape of the object as shown in FIG. 3. When the shape of the surface of the object is constant, the deformation amount of the second propagating member 22 also is constant. When probing the weld portion 53, however, the shape is different for each weld portion 53. For example, the diameter, the depth, etc., are different for each weld portion 53. Therefore, the deformation amount of the second propagating member 22 when probing is different for each weld portion 53.

When the deformation amount of the second propagating member 22 is different, the distance between the first propagating member 21 and the joined body 50 changes. For example, when probing a deeper weld portion 53, the deformation amount of the second propagating member 22 is large, and the distance between the first propagating member 21 and the joined body 50 is shorter than normal. As a result, the surface position in the intensity data also changes. When the surface position changes, the range of the data extracted from the intensity data changes. When data is extracted in an improper range, the accuracy of the calculated tilt decreases, or the accuracy of the inspection decreases.

For this problem, according to the embodiment, the processing device 90 detects the surface position of the object in the intensity data. By detecting the surface position, the surface position in the intensity data can be appropriately set, even when the deformation amount of the second propagating member 22 changes for each weld portion 53. For example, based on the detected surface position, the portion of the intensity data can be extracted more appropriately, or a more accurate inspection result is obtained.

According to the embodiment, a processing system and a processing method can be provided in which the time necessary for the probing can be reduced, the surface position in the intensity data can be detected, and the convenience is good.

Favorable specific examples of the detection device 20 will now be described.

The first propagating member 21 and the second propagating member 22 include resins. As one specific example, the first propagating member 21 includes an acrylic. The second propagating member 22 includes segmented polyurethane.

The detection device 20 transmits an ultrasonic wave toward a joined body and detects a reflected wave of the ultrasonic wave. The acoustic impedance of a general steel plate used in joining is about 4.5×10⁷ (Pa·s/m). It is favorable for the acoustic impedances of the first and second propagating members 21 and 22 each to be greater than 1.0×10⁵ (Pa·s/m) and less than 1.0×10⁸ (Pa·s/m) so that the ultrasonic wave sufficiently propagates between the detection device 20 and the joined body. The acoustic impedance can be measured in accordance with JIS A 1405-1 (ISO 10534-1). The acoustic impedance may be measured in accordance with JIS A 1409 (ISO 354).

To suppress the deformation of the first propagating member 21, it is favorable for the Rockwell hardness (M scale) of the first propagating member 21 to be greater than 80 and less than 110. The Rockwell hardness can be measured in accordance with JIS Z 2245 (ISO 2039-2). It is favorable for the hardness of the second propagating member 22 measured by an Asker durometer Type F to be greater than 40 and less than 60 so that the second propagating member 22 can easily deform according to the surface shape of the object.

In the example of FIG. 2, the fixture 23 includes a plate member 23a and a fastener 23b. The plate member 23a includes a first end part E1 and a second end part E2. The first end part E1 is tightened and fixed to the housing 25h by the fastener 23b. The fastener 23b is, for example, a screw. The plate member 23a extends along the direction from the housing 25h toward the second propagating member 22. The second end part E2 that is at the side opposite to the first end part E1 is bent so that the second propagating member 22 is positioned between the first propagating member 21 and the second end part E2. A portion of the second propagating member 22 is clamped by the second end part E2 and the first propagating member 21.

The plate member 23a may be an elastic leaf spring. The plate member 23a applies an elastic force in the direction of pressing the second propagating member 22 toward the first propagating member 21. Instead of the plate member 23a, the second propagating member 22 may be pressed by a linear member such as a hard steel wire, etc. The specific structure of the fixture 23 is modifiable as appropriate as long as one end of the fixture 23 can be fixed with respect to the housing 25h, and the other end of the fixture 23 includes a pressing member that can press the second propagating member 22 toward the first propagating member 21.

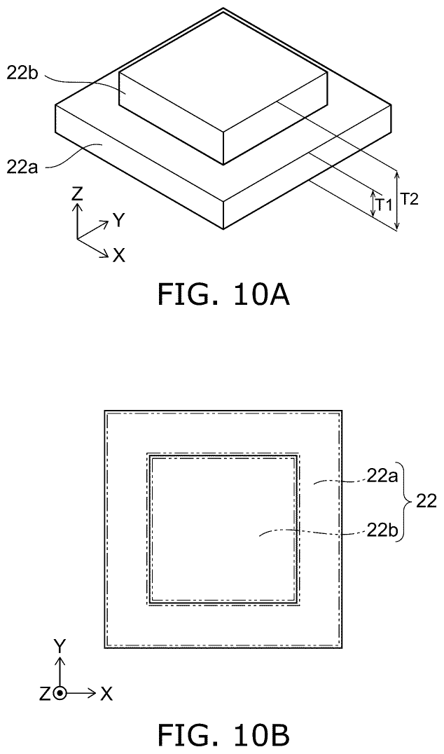

FIGS. 10A and 10B are a perspective view and a bottom view showing the second propagating member.

As shown in FIGS. 10A and 10B, the second propagating member 22 includes a first part 22a and a second part 22b.

The first part 22a is positioned at the outer perimeter of the second propagating member 22 and is pressed by the fixture 23. The second part 22b is surrounded with the first part 22a.

The first part 22a is positioned around the second part 22b along the X-Y plane. For example, the second part 22b is positioned at the center of the second propagating member 22.

The second part 22b protrudes further than the first part 22a in the Z-direction. For example, as illustrated in FIG. 10A, a thickness T2 of the second part 22b is greater than a thickness T1 of the first part 22a. The thickness corresponds to the Z-direction length.

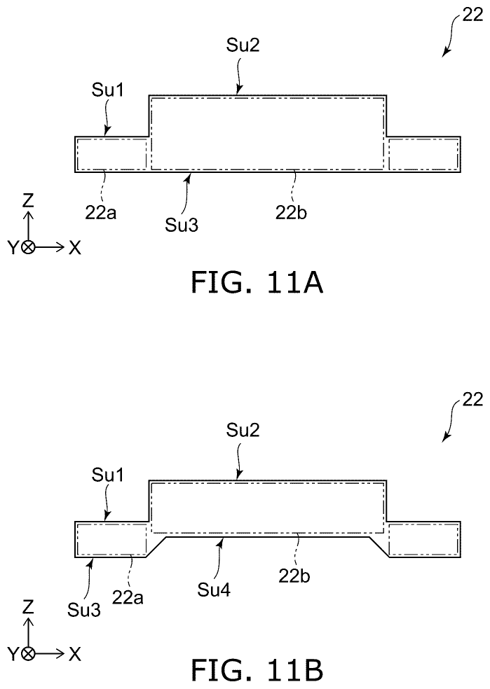

FIGS. 11A and 11B are side views showing second propagating members.

Examples of specific structures of the second propagating member 22 will now be described. As illustrated in FIG. 11A, the first part 22a and the second part 22b respectively include a first surface Su1 and a second surface Su2 crossing the Z-direction. The first part 22a and the second part 22b also include a common third surface Su3 crossing the Z-direction. The third surface Su3 is positioned at the side opposite to the first and second surfaces Su1 and Su2. For example, the first surface Su1, the second surface Su2, and the third surface Su3 are parallel to each other. The Z-direction position of the first surface Su1 is between the Z-direction position of the second surface Su2 and the Z-direction position of the third surface Su3.

As another example, the first part 22a and the second part 22b may respectively include the third surface Su3 and a fourth surface Su4 crossing the Z-direction as illustrated in FIG. 11B. The third surface Su3 is positioned at the side opposite to the first surface Su1. The fourth surface Su4 is positioned at the side opposite to the second surface Su2. For example, the first surface Su1, the second surface Su2, the third surface Su3, and the fourth surface Su4 are parallel to each other. The Z-direction position of the first surface Su1 and the Z-direction position of the fourth surface Su4 are between the Z-direction position of the second surface Su2 and the Z-direction position of the third surface Su3.

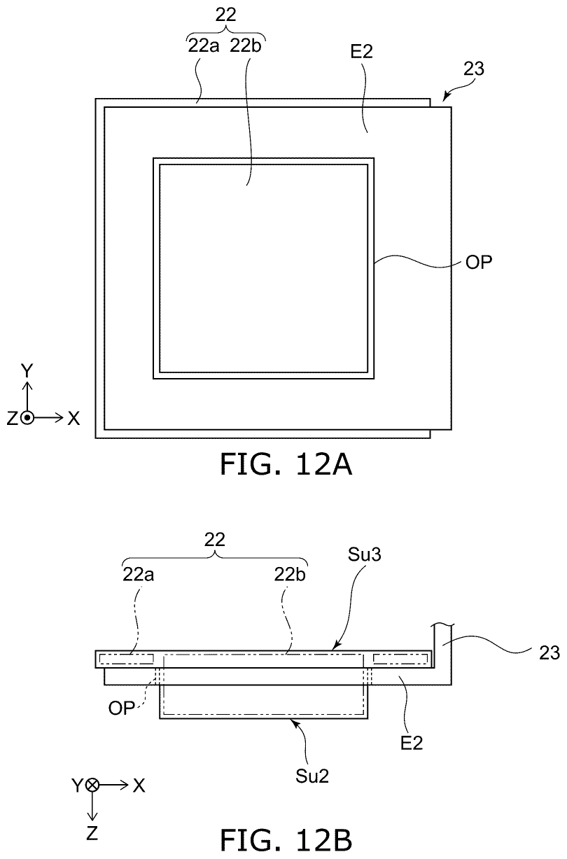

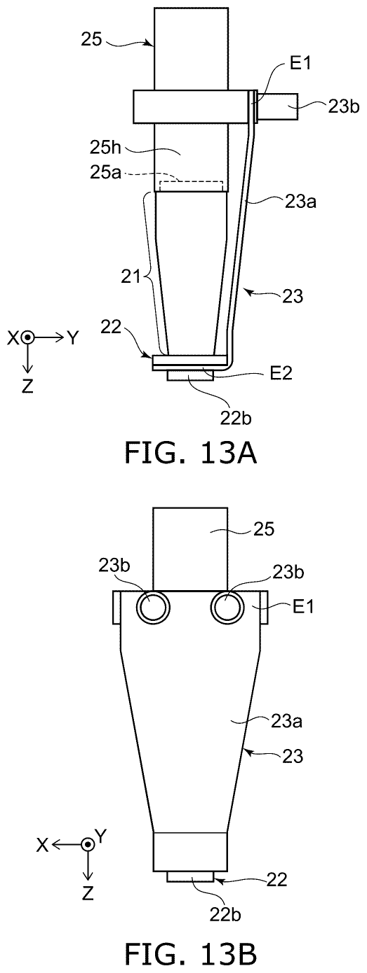

FIGS. 12A and 12B are a bottom view and a side view showing a portion of the detection device according to the embodiment. FIGS. 13A and 13B are side views showing the detection device according to the embodiment.

As illustrated in FIGS. 12A and 12B, the first part 22a is pressed toward the first propagating member 21 by the fixture 23. As a result, the second propagating member 22 is closely adhered to the first propagating member 21 so that there is no gap between the first propagating member 21 and the second propagating member 22. For example, the first part 22a is deformed, and the thickness of the first part 22a is reduced.

An opening OP is formed in the second end part E2 of the plate member 23a. In the example of FIGS. 12A and 12B, the opening OP is a hole extending through the second end part E2 in the thickness direction of the second end part E2. The thickness direction of the second end part E2 is parallel to the Z-direction when the second end part E2 presses the second propagating member 22.

The fixture 23 fixes the second propagating member 22 so that the second part 22b protrudes further than the first part 22a and the second end part E2 in the Z-direction. Specifically, the second part 22b of the second propagating member 22 is inserted into the opening OP. As a result, when the first part 22a is pressed by the fixture 23, the second part 22b protrudes further than the second end part E2 of the fixture 23 in the Z-direction as illustrated in FIGS. 12B, 13A, and 13B. In other words, as illustrated in FIG. 12B, the Z-direction position of the second end part E2 is between the Z-direction position of the second surface Su2 and the Z-direction position of the third surface Su3.

Because the second part 22b protrudes further than the first part 22a, the volume of the second part 22b protruding from the second end part E2 of the fixture 23 can be increased. In other words, the volume of the second part 22b deforming along the surface shape of the object can be increased. As a result, the second propagating member 22 easily fills between the first propagating member 21 and the object.

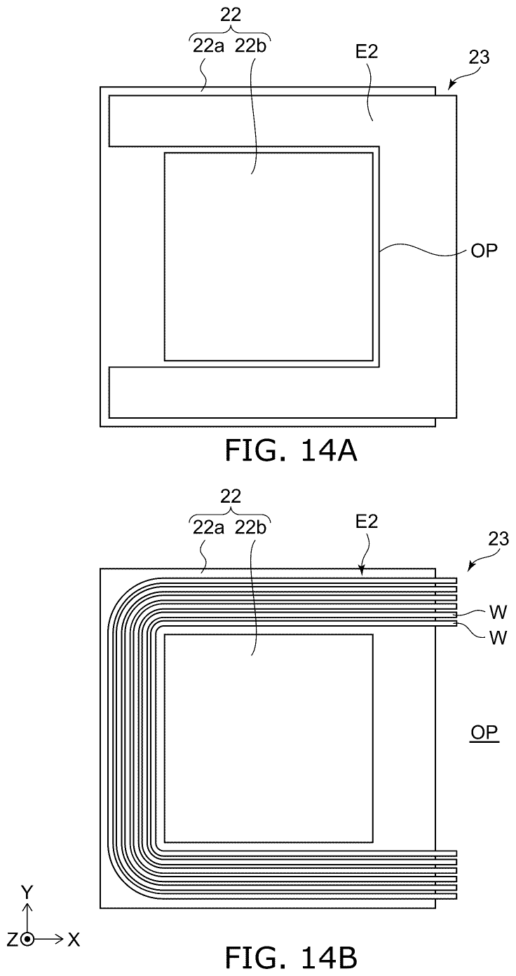

FIGS. 14A and 14B are bottom views showing portions of the detection device according to the embodiment.

As illustrated in FIG. 14A, the opening OP may extend in a slit configuration in one direction. As illustrated in FIG. 14B, the plate member 23a may include multiple wires W. The opening OP is formed at a position at which the wires W are not located.

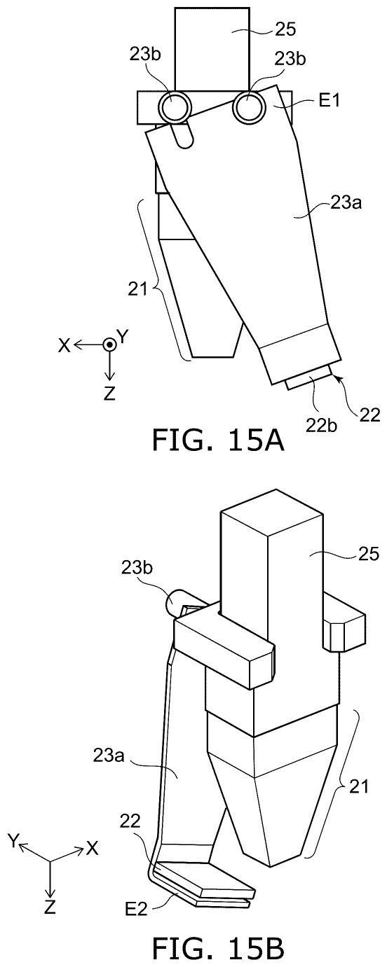

FIGS. 15A and 15B are a side view and a perspective view illustrating the detection device according to the embodiment.

The fixture 23 detachably fixes the second propagating member 22 to the first propagating member 21. In other words, by using the fixture 23, the state can be switched between a state in which the second propagating member 22 fixed with respect to the first propagating member 21 and a state in which the second propagating member 22 is not fixed with respect to the first propagating member 21.

For example, as illustrated in FIGS. 15A and 15B, the plate member 23a can be detached from the housing 25h by loosening the fastener 23b. The second end part E2 separates from the first propagating member 21 when the plate member 23a is detached from the housing 25h. In other words, the distance between the second end part E2 and the first propagating member 21 increases. As a result, the second propagating member 22 is no longer pressed by the second end part E2. The second propagating member 22 is detachable. The second propagating member 22 can be detached, and another new second propagating member 22 can be mounted.

Or, the plate member 23a may be a leaf spring. In such a case, the second end part E2 may be separated from the first propagating member 21 by deforming the plate member 23a. The second propagating member 22 is no longer pressed by the second end part E2; and the second propagating member 22 can be detached.

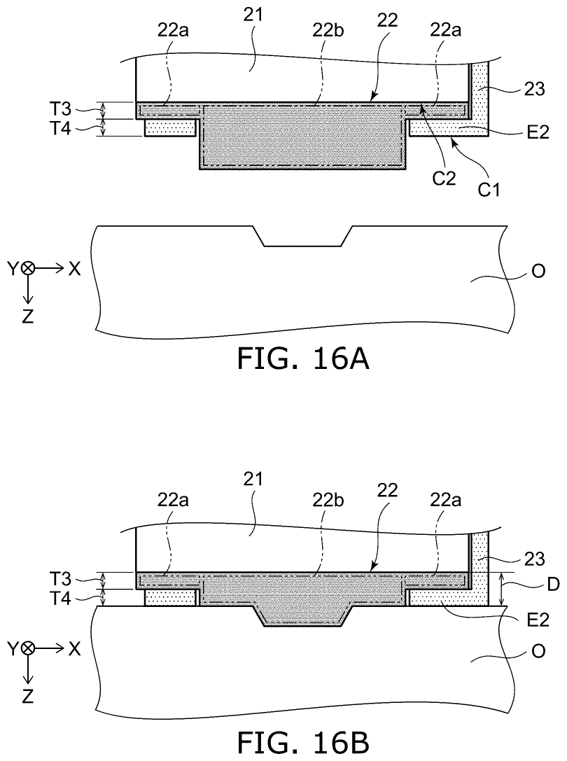

FIGS. 16A and 16B are side views illustrating the distal end of the detection device according to the embodiment.

FIG. 16A illustrates a state before the second propagating member 22 contacts an object O. FIG. 16B illustrates a state after the second propagating member 22 contacts the object O. As illustrated in FIGS. 16A and 16B, the second part 22b of the second propagating member 22 deforms and is mashed when contacting the object O. The thickness of the second part 22b is reduced.

The second part 22b deforms so that the fixture 23 also contacts the object O. The fixture 23 is harder than the second propagating member 22 and has sufficient rigidity. Therefore, unlike the second propagating member 22, the fixture 23 substantially does not deform, even when contacting the object O. The first part 22a that is already being pressed by the fixture 23 also is more difficult to deform than the second part 22b. It is easy to set a distance D between the first propagating member 21 and the object O by the fixture 23 contacting the object O. Fluctuation of the distance D due to the degree of the deformation of the second propagating member 22 can be suppressed.

The fixture 23 includes a first contact surface C1 facing the object O. The first contact surface C1 faces the Z-direction. The first contact surface C1 also may contact the object when the second propagating member 22 contacts the object. For example, the second end part E2 of the plate member 23a includes the first contact surface C1. In the example, the first contact surface C1 is formed of one surface. The first contact surface C1 may be formed of multiple lines or multiple points. The first propagating member 21 includes a second contact surface C2 that contacts the second propagating member 22. Favorably, the first contact surface C1 is parallel to the second contact surface C2. For example, the first contact surface C1 and the second contact surface C2 are parallel to the X-direction and Y-direction, which are the arrangement directions of multiple detection elements described below.

For example, the first contact surface C1 of the fixture 23 contacts the object O when the second part 22b is mashed by contact with the object O. When the first contact surface C1 and the second contact surface C2 are parallel, the distance D is set by a thickness T4 of the second end part E2 and a thickness T3 of the deformed first part 22a. For example, the distance D can be set to a prescribed value by pressing the detection device 20 toward the object O until the first contact surface C1 has surface contact with the object O. Fluctuation of the distance D at multiple points in the X-Y plane can be reduced. As a result, fluctuation of the reflected wave intensity for each probing can be reduced, and fluctuation of the reflected wave intensity at multiple points in the X-Y plane can be reduced.

“Parallel” may include not only exactly parallel, but also, for example, fluctuation of the manufacturing processes, etc. There may be tilt between the arrangement directions mentioned above and the first and second contact surfaces C1 and C2 within a range that does not cause problems in the detection. For example, the first contact surface C1 and the second contact surface C2 are considered to be substantially parallel when the angles between the first and second contact surfaces C1 and C2 and any two of the arrangement directions are greater than −5 degrees and less than +5 degrees.

### First Modification

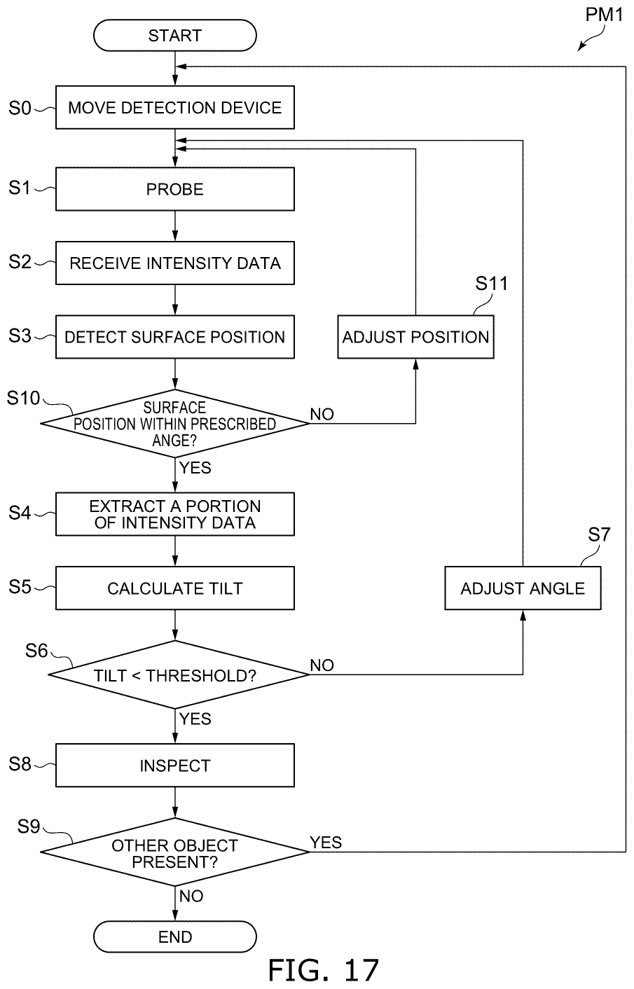

FIG. 17 is a flowchart showing a processing method according to a first modification of the embodiment.

Compared to the processing method PM, the processing method PM1 according to the first modification shown in FIG. 17 further includes steps S10 and S11. First, similarly to the processing method PM, steps S0 to S3 are performed. When the surface position is detected in step S3, the processing device 90 determines whether or not the surface position is within a prescribed range (step S10).

When the surface position is outside the prescribed range, the control device 12 moves the detection device 20 by operating the manipulator 11. As a result, the position of the detection device 20 is adjusted so that the surface position approaches the prescribed range in the intensity data (step S11). After adjusting the position, step S1 is re-performed. When the surface position is within the prescribed range, the processing device 90 uses the surface position to extract a portion of the intensity data (step S4). Subsequently, step S5 and subsequent steps are performed similarly to the processing method PM.

According to the processing method PM1 according to the first modification, similarly to the processing method PM, a more appropriate range can be extracted from the intensity data. However, in the processing method PM1, compared to the processing method PM, the necessary time is longer because the position adjustment and the re-probing are performed. From the perspective of reducing the necessary time, the processing method PM is more favorable than the processing method PM1.

### Second Modification

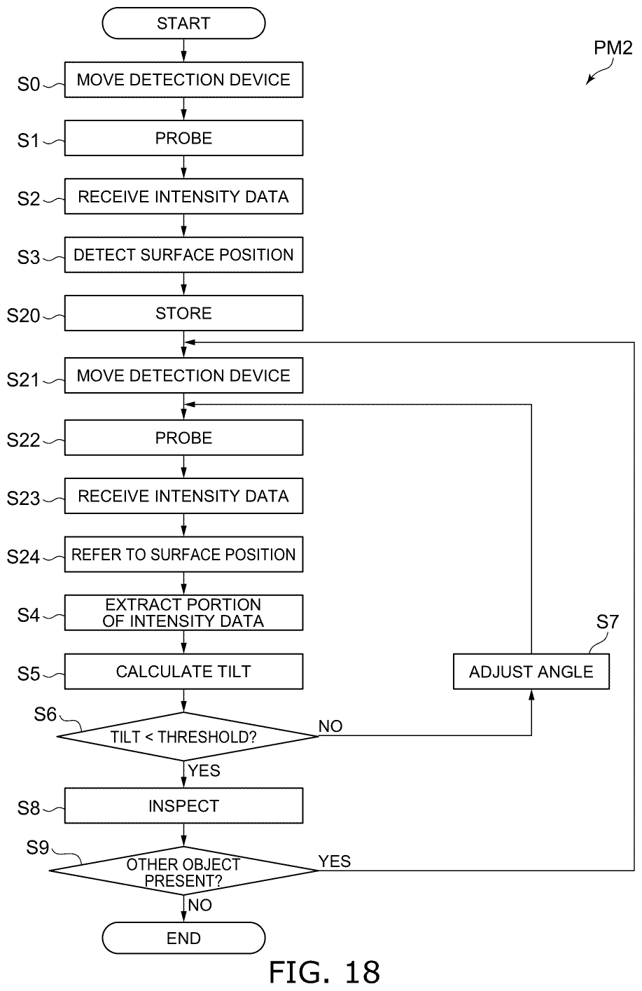

FIG. 18 is a flowchart showing a processing method according to a second modification of the embodiment.

Compared to the processing method PM, the processing method PM2 according to the second modification shown in FIG. 18 further includes steps S20 to S24. First, similarly to the processing method PM, steps S0 to S3 are performed. When the surface position is detected in step S3, the processing device 90 stores the surface position (step S20).

The control device 12 causes the distal end of the detection device 20 to contact the object by operating the manipulator 11 (step S21). At this time, the object that is contacted by the detection device 20 may be the same as the object contacted by the detection device 20 in step S0, or may be different from the object contacted by the detection device 20 in step S0. When the object is different between steps S0 and S21, the objects have substantially the same structure. For example, the object that is contacted by the detection device 20 in step S0 is used as a test piece.

The processing device 90 causes the detection device 20 to probe (step S22). The processing device 90 receives the intensity data obtained by the probing from the detection device 20 (step S23). The processing device 90 refers to the surface position stored in step S20 (step S24). In step S4, a portion of the intensity data is extracted using the referenced surface position. In other words, in the processing method PM2 according to the second modification, the intensity data that is used to detect the surface position is different from the intensity data of which a portion is extracted based on the surface position. Subsequently, step S5 and subsequent steps are performed similarly to the processing method PM.

Step S21 is re-performed when other objects are present in step S9. Or, step S0 may be re-performed. The step to be performed can be selected according to whether or not the structure of the object for which the surface position is detected in step S3 and the structure of the object for which the probing will be performed in the next step S22 are the same.

According to the processing method PM2 according to the second modification, the surface position can be pre-detected for the object to be probed in step S22. Therefore, the time from the probing in step S22 until the extracted data is obtained can be reduced. For example, the processing method PM2 is especially favorable when it is desirable to reduce the time from the probing to the inspection in a mass production line, etc.

### Example

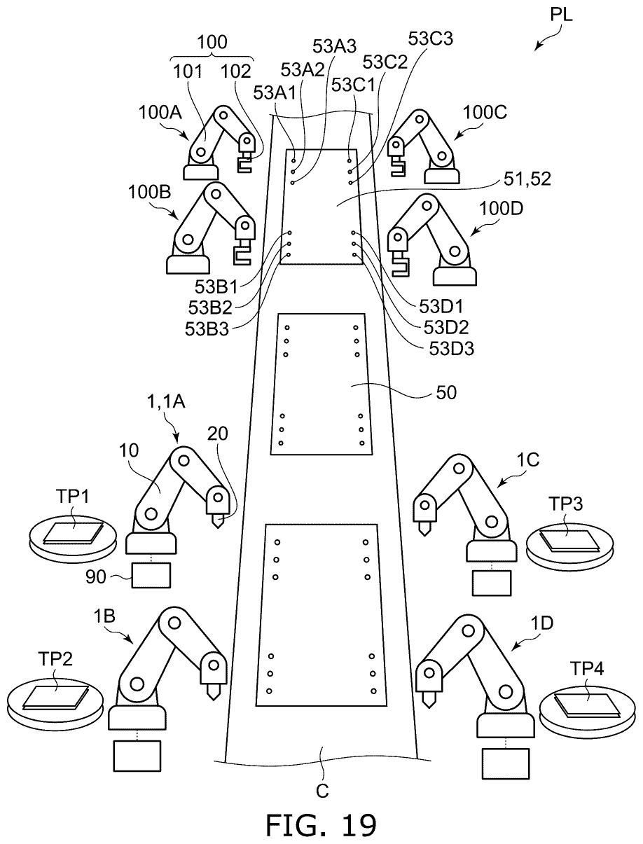

FIG. 19 is a schematic view showing an example using the processing system according to the embodiment.

In the example shown in FIG. 19, the processing system 1 is used in a production line PL. In addition to the multiple processing systems 1, the production line PL includes multiple welding systems 100. Each welding system 100 includes a manipulator 101, and a welding device 102 mounted to the manipulator 101. The welding systems 100 also include robot controllers, power supply devices, etc., that are not illustrated.

Each welding system 100 performs resistance spot welding of the metal members 51 and 52. The joined body 50 is made thereby. The joined body 50, the metal member 51, and the metal member 52 are, for example, a portion of a vehicle body. The multiple processing systems 1 respectively inspect the multiple weld portions 53 of the joined body 50.

For example, the multiple welding systems 100 include welding systems 100A to 100D. Weld portions 53A1 to 53A3 are formed by the welding system 100A. Similarly, weld portions 53B1 to 53B3, weld portions 53C1 to 53C3, and weld portions 53D1 to 53D3 are formed by the welding systems 100B to 100D. When the welding of one set of the metal members 51 and 52 by the welding systems 100A to 100D is completed, a conveyor C transports the joined body 50. Another set of the metal members 51 and 52 is transported to the location at which the welding systems 100A to 100D are installed. The joined body 50 is transported to the location at which processing systems 1A to 1D are installed.

The multiple processing systems 1 include the processing systems 1A to 1D. The weld portions 53A1 to 53A3 are inspected by the processing system 1A. Similarly, the weld portions 53B1 to 53B3, the weld portions 53C1 to 53C3, and the weld portions 53D1 to 53D3 are inspected by the processing systems 1B to 1D.

The processing systems 1A to 1D cannot inspect the joined body 50 during the period in which the joined body 50 is transported by the conveyor C. For example, multiple test pieces TP1 to TP4 are located respectively adjacent to the processing systems 1A to 1D. Each test piece has substantially the same structure as the weld portion 53 vicinity of the joined body 50. While the conveyor C transports the joined body 50, the processing systems 1A to 1D detect the surface positions by respectively using the test pieces TP1 to TP4, and store the surface positions. In other words, steps S0 to S3 and S20 of the processing method PM2 shown in FIG. 18 are performed on the test pieces TP1 to TP4 (examples of the object).

When the transport of the joined body 50 by the conveyor C is completed, the processing systems 1A to 1D inspect the joined body 50 (an example of another object). At this time, the processing systems 1A to 1D utilize the surface positions detected using the test pieces TP1 to TP4, and extract portions of the intensity data (other intensity data) obtained from the joined body 50. In other words, steps S21 to S24 and S4 to S9 of the processing method PM2 shown in FIG. 18 are performed on the weld portions 53 of the joined body 50.

According to the example, a first operation that uses the test pieces and a second operation on the joined body 50 are alternately performed. The first operation includes the transmission of the ultrasonic wave toward the test piece by the detector 25, the reception of the reflected wave by the detector 25, and the detection of the surface position by the processing device 90. The second operation includes the transmission of the ultrasonic wave toward the joined body 50 by the detector 25, the reception of the reflected wave by the detector 25, and the extraction of the portion of the intensity data of the joined body 50 by the processing device 90.

According to the example, the period that the conveyor C transports the joined body 50 can be utilized to detect the surface positions to be utilized in the inspection of the joined body 50 before inspecting the joined body 50. As a result, the time necessary to inspect the joined body 50 can be reduced. For example, the suitability for mass production of the joined body 50 can be improved.

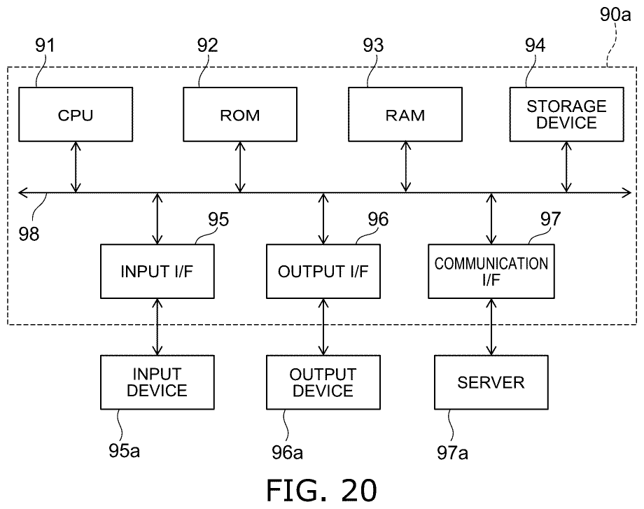

FIG. 20 is a schematic view illustrating a hardware configuration.

For example, a computer 90a illustrated in FIG. 20 can be used as the processing device 90. The computer 90a includes a CPU 91, ROM 92, RAM 93, a storage device 94, an input interface 95, an output interface 96, and a communication interface 97.

The ROM 92 stores programs that control operations of the computer 90a. The ROM 92 stores programs necessary for causing the computer 90a to realize the processing described above. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs.

The input interface (I/F) 95 connects the processing device 90 and an input device 95a. The input I/F 95 is, for example, a serial bus interface such as USB, etc. The CPU 91 can read various data from the input device 95a via the input I/F 95.

The output interface (I/F) 96 connects the processing device 90 and an output device 96a. The output I/F 96 is, for example, an image output interface such as Digital Visual Interface (DVI), High-Definition Multimedia Interface (HDMI (registered trademark)), etc. The CPU 91 can transmit data to the output device 96a via the output I/F 96 and cause the output device 96a to display an image.

The communication interface (I/F) 97 connects the processing device 90 and a server 97a outside the processing device 90. The communication I/F 97 is, for example, a network card such as a LAN card, etc. The CPU 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a CPU to execute the instructions recited in the program based on the program. In the computer, the acquisition (or the reading) of the program may be performed via a network.

The embodiment of the invention includes the following features.

### APPENDIX 1

A processing system, including:
a manipulator;
a detection device mounted to the manipulator, the detection device including
   a detector configured to transmit an ultrasonic wave toward an object and detect a reflected wave,
   a first propagating member mounted to the detector, the ultrasonic wave propagating through the first propagating member, and
   a second propagating member mounted to the first propagating member, the ultrasonic wave propagating through the second propagating member, the second propagating member being softer than the first propagating member; and
a processing device configured to receive intensity data from the detector and detect a surface position of the object in the intensity data, the intensity data being of an intensity of the reflected wave.

### APPENDIX 2

The system according to appendix 1, in which
the processing device extracts a portion of the intensity data based on the surface position.

### APPENDIX 3

The system according to appendix 2, in which
the processing device calculates a tilt of the detection device with respect to the object by using the extracted portion of the intensity data.

### APPENDIX 4

The system according to appendix 2 or 3, in which
the object is a joined body in which a weld portion is formed, and
the processing device inspects the weld portion by using the extracted portion of the intensity data.

### APPENDIX 5

The system according to any one of appendixes 1 to 4, in which
the manipulator moves the detection device so that the surface position approaches a preset range.

### APPENDIX 6

The system according to any one of appendixes 1 to 5, in which
the processing device receives other intensity data of the intensity of the reflected wave from another object, and
the processing device extracts a portion of the other intensity data based on the surface position.

### APPENDIX 7

The system according to appendix 6, in which
the other object is a joined body in which a weld portion is formed, and
the processing device inspects the weld portion by using the extracted portion of the other intensity data.

### APPENDIX 8

The system according to appendix 6, in which
a first operation and a second operation are alternately repeated,
the first operation includes:
   the transmission of the ultrasonic wave toward the object by the detector;
   a reception of the reflected wave by the detector; and
   the detection of the surface position by the processing device, and
the second operation includes:
   a transmission of the ultrasonic wave toward the other object by the detector;
   a reception of the reflected wave by the detector; and
   the extraction of the portion of the other intensity data by the processing device.

### APPENDIX 9

The system according to any one of appendixes 1 to 8, in which
the detection device further includes a fixture configured to detachably fix the second propagating member with respect to the first propagating member.

### APPENDIX 10

The system according to appendix 9, in which
the fixture includes a first contact surface facing the object,
   the first propagating member includes a second contact surface contacting the second propagating member, and
   the first contact surface is parallel to the second contact surface.

### APPENDIX 11

The system according to any one of appendixes 1 to 10, in which
the processing device detects a first peak and a second peak in the intensity data and uses a position of the second peak as the surface position,
the first peak is a peak that is first to exceed a first threshold, and
the second peak is a peak that is first to exceed a second threshold after the first peak.

### APPENDIX 12

A processing device,
the processing device being configured to receive intensity data from a detection device and detect a surface position of an object in the intensity data,
the detection device being mounted to a manipulator,
the detection device including:
   a detector configured to transmit an ultrasonic wave toward the object and detect a reflected wave;
   a first propagating member mounted to the detector, the ultrasonic wave propagating through the first propagating member; and
   a second propagating member mounted to the first propagating member, the ultrasonic wave propagating through the second propagating member, the second propagating member being softer than the first propagating member,
the intensity data being of an intensity of the reflected wave.

### APPENDIX 13

A processing method, including:
receiving intensity data from a detection device; and
detecting a surface position of an object in the intensity data,
the detection device being mounted to a manipulator,
the detection device including
   a detector configured to transmit an ultrasonic wave toward the object and detect a reflected wave,
   a first propagating member mounted to the detector, the ultrasonic wave propagating through the first propagating member, and
   a second propagating member mounted to the first propagating member, the ultrasonic wave propagating through the second propagating member, the second propagating member being softer than the first propagating member,
the intensity data being of an intensity of the reflected wave.

### APPENDIX 14

A program, when executed by a computer, causing the computer to perform the processing method according to appendix 13.

### APPENDIX 15

A non-transitory computer-readable storage medium configured to store the program according to appendix 14.

According to embodiments above, the processing system 1, the processing method, or the processing device 90 can be provided in which the convenience is good. For example, the time necessary for the probing can be reduced, and the surface position can be detected in the intensity data. Similar effects can be obtained by using a program that causes a computer to perform the processing method.

Although some embodiments of the invention have been described above, these embodiments have been presented by way of example and are not intended to limit the scope of the invention. These novel embodiments can be implemented in a variety of other forms, and various omissions, substitutions, changes, and the like can be made without departing from the gist of the invention. Such embodiments or their modifications fall within the scope of the invention as defined in the claims and their equivalents as well as within the scope and gist of the invention. The above-described embodiments can be implemented in combination with each other.

What is claimed is:

1. A processing system, comprising:
a manipulator;
a detection device mounted to the manipulator, the detection device including
a detector configured to transmit an ultrasonic wave toward an object and detect a reflected wave,
a first propagating member mounted to the detector, the ultrasonic wave propagating through the first propagating member, and
a second propagating member mounted to the first propagating member, the ultrasonic wave propagating through the second propagating member, the second propagating member being softer than the first propagating member; and
a processing device configured to receive intensity data from the detector and detect a surface position of the object in the intensity data, the intensity data being of an intensity of the reflected wave.

2. The system according to claim 1, wherein
the processing device extracts a portion of the intensity data based on the surface position.

3. The system according to claim 2, wherein
the processing device calculates a tilt of the detection device with respect to the object by using the extracted portion of the intensity data.

4. The system according to claim 2, wherein
the object is a joined body in which a weld portion is formed, and
the processing device inspects the weld portion by using the extracted portion of the intensity data.

5. The system according to claim 1, wherein
the manipulator moves the detection device so that the surface position approaches a preset range.

6. The system according to claim 1, wherein
the processing device receives other intensity data of the intensity of the reflected wave from another object, and
the processing device extracts a portion of the other intensity data based on the surface position.

7. The system according to claim 6, wherein
the other object is a joined body in which a weld portion is formed, and
the processing device inspects the weld portion by using the extracted portion of the other intensity data.

8. The system according to claim 6, wherein
a first operation and a second operation are alternately repeated,
the first operation includes:
the transmission of the ultrasonic wave toward the object by the detector;
a reception of the reflected wave by the detector; and
the detection of the surface position by the processing device, and
the second operation includes:
a transmission of the ultrasonic wave toward the other object by the detector;
a reception of the reflected wave by the detector; and
the extraction of the portion of the other intensity data by the processing device.

9. The system according to claim 1, wherein
the detection device further includes a fixture configured to detachably fix the second propagating member with respect to the first propagating member.

10. The system according to claim 9, wherein
the fixture includes a first contact surface facing the object,
the first propagating member includes a second contact surface contacting the second propagating member, and
the first contact surface is parallel to the second contact surface.

11. The system according to claim 1, wherein
the processing device detects a first peak and a second peak in the intensity data and uses a position of the second peak as the surface position,
the first peak is a peak that is first to exceed a first threshold, and
the second peak is a peak that is first to exceed a second threshold after the first peak.

12. A processing device,
the processing device being configured to receive intensity data from a detection device and detect a surface position of an object in the intensity data,
the detection device being mounted to a manipulator,
the detection device including:
a detector configured to transmit an ultrasonic wave toward the object and detect a reflected wave;
a first propagating member mounted to the detector, the ultrasonic wave propagating through the first propagating member; and
a second propagating member mounted to the first propagating member, the ultrasonic wave propagating through the second propagating member, the second propagating member being softer than the first propagating member,
the intensity data being of an intensity of the reflected wave.

13. A processing method, comprising:
receiving intensity data from a detection device; and
detecting a surface position of an object in the intensity data,
the detection device being mounted to a manipulator,
the detection device including
a detector configured to transmit an ultrasonic wave toward the object and detect a reflected wave,
a first propagating member mounted to the detector, the ultrasonic wave propagating through the first propagating member, and
a second propagating member mounted to the first propagating member, the ultrasonic wave propagating through the second propagating member, the second propagating member being softer than the first propagating member,
the intensity data being of an intensity of the reflected wave.

14. A non-transitory computer-readable storage medium,
the storage medium being configured to store a program,
the program, when executed by a computer, causing the computer to perform the processing method according to claim 13.
